(19) United States
(12) Patent Application Publication
(10) Pub. No.: US 2026/0027879 A1
(43) Pub. Date: Jan. 29, 2026

(54) Covering Device and Vehicle-Mounted Device

(71) Applicant: Illinois Tool Works Inc., Glenview, IL (US)

(72) Inventor: Gang Yu, Shanghai (CN)

(21) Appl. No.: 19/280,378

(22) Filed: Jul. 25, 2025

(30) Foreign Application Priority Data
Jul. 26, 2024 (CN) 202411017716.2
Jul. 17, 2025 (CN) 202510987862.6

(51) Int. Cl. B60J 11/02; B60R 11/04

(52) U.S. Cl. CPC B60J 11/025; B60R 11/04

(57) ABSTRACT

A covering device included a mounting base, a covering member, a receiving opening cover, and a driving device. The mounting base defines a receiving cavity and is provided with a receiving opening. The covering member is connected to the mounting base and has a covering state and an idle state. The receiving opening cover is connected to the covering member and has an open state and a closed state. The driving device is configured to drive the covering member to switch between the covering state and the idle state. When the covering member is in the idle state, the receiving opening cover is in the open state, and the covering member is received in the receiving cavity and covers the receiving opening. When the covering member is in the covering state, the covering member is at least partially located outside the receiving cavity and the receiving opening, and the receiving opening cover is driven by the covering member to the closed state.

### RELATED APPLICATIONS

The present application claims the benefit of Chinese Patent Application Nos. 202411017716.2, filed Jul. 26, 2024, and 202510987862.6, filed Jul. 17, 2025, each titled “Covering Device and Vehicle-Mounted Device,” the contents of which are hereby incorporated by reference.

### TECHNICAL FIELD

The present disclosure relates to the field of covering devices, and in particular to a covering device in a vehicle-mounted device.

### BACKGROUND

An existing vehicle-mounted device includes a vehicle-mounted member housing and a covering device. The covering device includes a covering member to cover an opening in the vehicle-mounted member housing. However, when the covering member covers the opening in the vehicle-mounted member housing, an opening of the covering device itself is in an open state, which makes the entry of dust easy.

### SUMMARY

The present disclosure relates generally to a vehicle-mounted device, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 is a perspective view of a vehicle-mounted device according to the present disclosure.

FIG. 2 is an exploded view of a covering device shown in FIG. 1.

FIG. 3 is a perspective view of a mounting base shown in FIGS. 1-2.

FIG. 4 is a partial exploded view of a first covering plate, a second covering plate, a shaft, a roll-up curtain and a transmission device shown in FIG. 2.

FIG. 5 is a partial perspective view of the covering device with the covering member in a covering state and a receiving opening cover in a closed state.

FIG. 6 is a partial side view of the covering device at a moment during the movement of the covering member from an idle state to the covering state and during the movement of the receiving opening cover 222 from an open state to the closed state.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been found that, in the prior art, even if an additional member is provided to cover the opening of the covering device itself, an additional driving device needs to be provided to drive the additional member. This results in a complex structure and large size for the vehicle-mounted device.

The present disclosure provides a covering device to address the aforementioned problem. The covering device comprises a mounting base, a covering member, a receiving opening cover, and a driving device. The mounting base defines a receiving cavity and is provided with a receiving opening. The covering member is connected to the mounting base and has a covering state and an idle state. The receiving opening cover is connected to the covering member and has an open state in which the receiving opening cover opens the receiving opening and a closed state in which the receiving opening cover closes the receiving opening. The driving device is configured to drive the covering member to switch between the covering state and the idle state. When the covering member is in the idle state, the receiving opening cover is in the open state, and the covering member is received in the receiving cavity and covers the receiving opening. When the covering member is in the covering state, the covering member is at least partially located outside the receiving cavity and the receiving opening, and the receiving opening cover is driven by the covering member to the closed state.

According to some embodiments, the covering device further comprises a shaft arranged on the mounting base. The receiving opening cover comprises a roll-up curtain, the roll-up curtain is connected to the shaft at a first end and is capable of being wound by being wound around the shaft, and the roll-up curtain is connected to the covering member at a second end opposite the first end and is capable of being unwound under the drive of the covering member. The receiving opening cover is in the open state when the roll-up curtain is wound, and the receiving opening cover is in the closed state when the roll-up curtain is unwound.

According to some embodiments, the covering member is configured to rotate about an axis relative to the mounting base to switch between the covering state and the idle state, and the roll-up curtain is movably connected to the covering member at the second end.

According to some embodiments, the covering member is provided with a receiving slot, the receiving slot being arranged at an angle to the axis. The covering device further comprises a connecting pin, the roll-up curtain is connected to the connecting pin at the second end, and the connecting pin is received in the receiving slot and is movable along the receiving slot. The connecting pin is at an end of the receiving slot away from the axis when the roll-up curtain is wound, and the connecting pin is at an end of the receiving slot close to the axis when the roll-up curtain is unwound.

According to some embodiments, the receiving slot is arranged perpendicular to the axis.

According to some embodiments, the covering member is provided with two receiving slots, the two receiving slots being located on opposite sides of the covering member, respectively. The covering device further comprises two connecting pins, the two connecting pins being received by the two receiving slots, respectively.

According to some embodiments, the covering device further comprises a reset member configured to cause the roll-up curtain to be wound during the switching of the covering member from the covering state to the idle state.

According to some embodiments, the covering member comprises a first covering plate and a second covering plate, the first covering plate being rotatably connected to the second covering plate, and the second covering plate being rotatably connected to the mounting base. When the covering member is in the idle state, the covering member is folded such that the first covering plate is superposed on the second covering plate, and when the covering member is in the covering state, the first covering plate and the second covering plate are joined together to collectively cover an object to be covered. The receiving slot is provided on the second covering plate.

According to some embodiments, the covering device further comprises a transmission device by which the driving device drives the first covering plate and the second covering plate to move.

According to some embodiments, the transmission device comprises a first gear, a second gear, a third gear and a drive belt. The first gear is fixedly connected to the second covering plate, and the driving device is configured to cause the first gear to rotate. The second gear is arranged on the second covering plate and meshes with the first gear. The third gear is fixedly connected to the first covering plate. The drive belt is arranged around the second gear and the third gear such that a rotation of the second gear causes a rotation of the third gear.

The present disclosure further provides a vehicle-mounted device. The vehicle-mounted device comprises a vehicle-mounted member housing and the aforementioned covering device. The vehicle-mounted member housing comprises a housing opening. The covering member opens the housing opening when the covering member is in the idle state, and the covering member covers the housing opening when the covering member is in the covering state.

According to some embodiments, the vehicle-mounted member housing is configured to house a vehicle-mounted member, and the vehicle-mounted member comprises a vehicle-mounted camera, a vehicle-mounted laser radar, a vehicle-mounted detection radar, a vehicle charging port or a vehicle rearview mirror.

Compared with the prior art, in the covering device of the present disclosure, the covering functions of the covering member and the receiving opening cover can be achieved by means of one driving device, without needing to provide a separate driving device for the receiving opening cover. Further, since the driving device can simultaneously move the covering member and the receiving opening cover, it takes short time to bring the covering member into the covering state and the receiving opening cover into the closed state.

Furthermore, since the covering member includes the first and second covering plates which move relative to each other, and the first covering plate is superposed on second covering plate when the covering member is in the idle state, the size of the covering member is small, resulting in a small opening area across the radius of the vehicle.

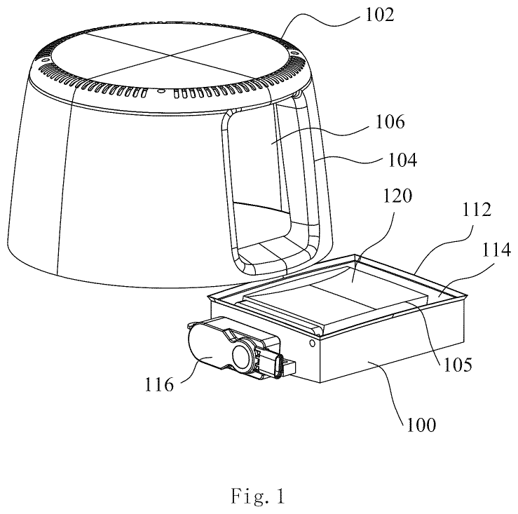

FIG. 1 is a perspective view of a vehicle-mounted device according to the present disclosure. As shown in FIG. 1, the vehicle-mounted device includes a vehicle-mounted member housing 102, a covering device 100, and a driving device 116. The vehicle-mounted member housing 102 defines a housing cavity 106 and a housing opening 104. The vehicle-mounted member is arranged in the housing cavity 106. The vehicle-mounted member comprises a vehicle-mounted camera, a vehicle-mounted laser radar, a vehicle-mounted detection radar, a vehicle charging port, or a vehicle rearview mirror. The covering device 100 includes a mounting base 112 and a covering member 120. The mounting base 112 defines a receiving cavity 114 and is provided with a receiving opening 105 at the top of the receiving cavity 114. The covering member 120 is connected to the mounting base 112 and has a covering state and an idle state. When the covering member 120 is in the idle state, the covering member 120 is housed in the receiving cavity 114, covering the receiving opening 105 and opening the housing opening 104. When the covering member 120 is in the covering state, the covering member 120 is at least partially located outside the receiving cavity 114 and the receiving opening 105 and covers the housing opening 104. In the present disclosure, the covering member 120 is configured to rotate relative to the mounting base 112 to switch between the covering state and the idle state. The driving device 116 is configured to drive the covering member 120 to rotate relative to the mounting base 112 so as to switch between the covering state and the idle state. In the present disclosure, the driving device 116 is arranged outside of the mounting base 112.

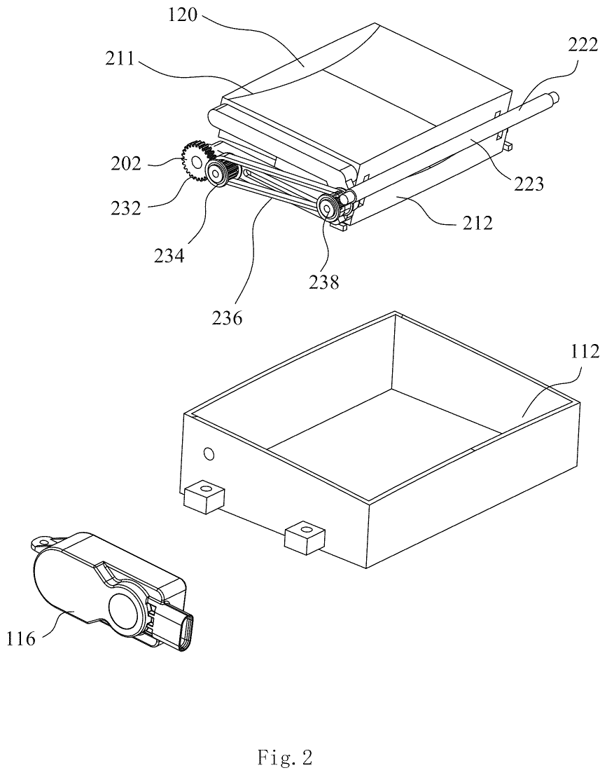

FIG. 2 is an exploded view of the covering device 100 shown in FIG. 1. As shown in FIG. 2, the covering member 120 includes a first covering plate 211 and a second covering plate 212. The first covering plate 211 is rotatably connected to the second covering plate 212. The second covering plate 212 is rotatably connected to the mounting base 112. When the covering member 120 is in the idle state, the covering member 120 is folded such that the first covering plate 211 is superposed on the second covering plate 212, and the first covering plate 211 can cover the receiving opening 105. When the covering member 120 is in the covering state, the first covering plate 211 and the second covering plate 212 are joined together to collectively cover an object to be covered (e.g., the housing opening 104).

As shown in FIG. 2, the covering device 100 further includes a transmission device 202. The driving device 116 drives the first covering plate 211 and the second covering plate 212 to move by means of the transmission device 202. In the present disclosure, the transmission device 202 includes a first gear 232, a second gear 234, a third gear 238, and a drive belt 236. The first gear 232 meshes with the second gear 234. The second gear 234 causes the third gear 238 to rotate by means of the drive belt 236 arranged around the second gear 234 and the third gear 238, so as to rotate the second covering plate 212.

As shown in FIG. 2, the covering device 100 further includes a receiving opening cover 222. The receiving opening cover 222 is connected to the covering member 120 and has an open state in which the receiving opening cover 222 opens the receiving opening 105 and a closed state in which the receiving opening cover 222 closes the receiving opening 105. The receiving opening cover 222 may be driven by the covering member 120 to move from the open state to the closed state. In the present disclosure, the receiving opening cover 222 includes a roll-up curtain 223. The roll-up curtain 223 can be wound and unwound. When the roll-up curtain 223 is wound, the receiving opening cover 222 is in the open position. When the roll-up curtain 223 is unwound, the receiving opening cover 222 is in the closed state.

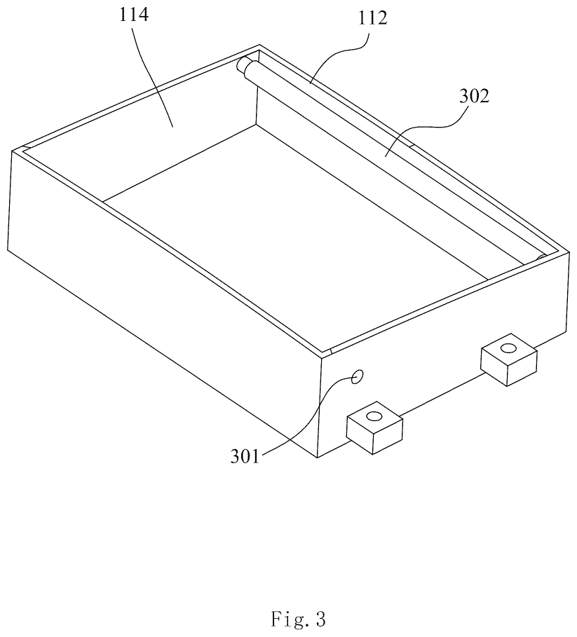

FIG. 3 is a perspective view of the mounting base 112 shown in FIGS. 1-2. As shown in FIG. 3, the mounting base 112 is substantially cuboid. A through hole 301 is provided in a side wall of the mounting base 112. A driving shaft (not shown) of the driving device 116 can pass through the through hole 301 to be connected to the first gear 232 located in the receiving cavity 114 to drive the first gear 232 to rotate.

As shown in FIG. 3, the covering device further includes a shaft 302. The shaft 302 is arranged in the receiving cavity 114 in a first direction (e.g., a front-rear direction) and is connected to the mounting base 112. The shaft 302 is used to receive the roll-up curtain 223 such that the roll-up curtain 223 can be wound around the shaft 302 when being wound.

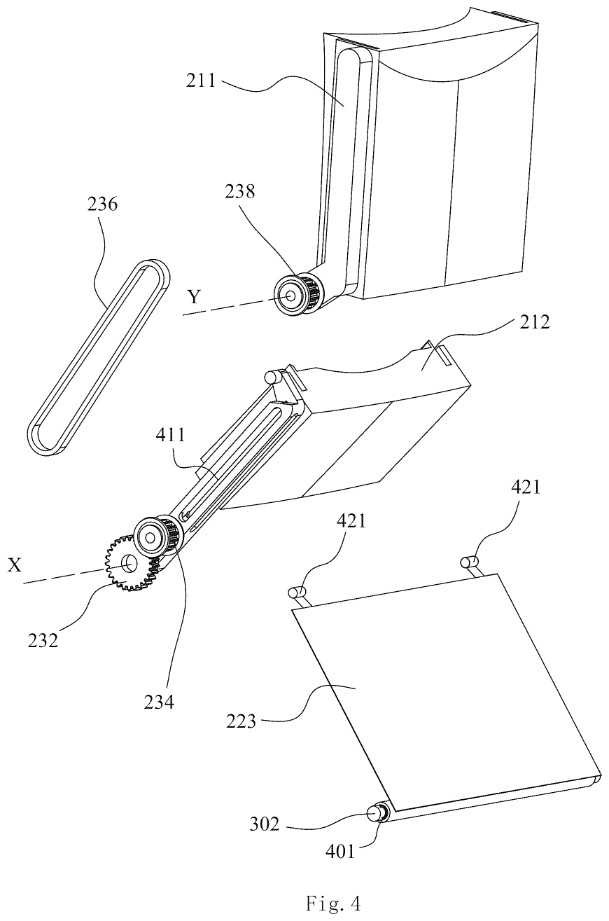

FIG. 4 is a partial exploded view of the first covering plate 211, the second covering plate 212, the shaft 302, the roll-up curtain 223 and the transmission device 202 shown in FIG. 2. As shown in FIG. 4, the first gear 232 is fixedly connected to the second covering plate 212. The second covering plate 212 is configured to rotate about an axis X relative to the mounting base 112. The axis X is a central axis of the first gear 232. In the present disclosure, the axis X extends in the first direction (e.g., the front-rear direction). The second gear 234 is fixedly connected to the second covering plate 212 and meshes with the first gear 232 such that the rotation of the first gear 232 can cause the rotation of the second gear 234. The third gear 238 is fixedly connected to the first covering plate 211. The drive belt 236 is arranged around the second gear 234 and the third gear 238 such that the rotation of the second gear 234 can cause the rotation of the third gear 238. More specifically, the first covering plate 211 is configured to rotate about an axis Y relative to the second covering plate 212. The axis Y is a central axis of the third gear 238. The axis Y extends in the first direction (e.g., the front-rear direction), so as to be parallel to the axis X. When the covering member 120 is in the idle state, the first covering plate 211 and the second covering plate 212 are folded and arranged substantially parallel to each other. When the covering member 120 is in the covering state, the first covering plate 211 and the second covering plate 212 are joined together and are substantially plate-shaped. In this case, the first covering plate and the second covering plate are substantially perpendicular to a plane in which the receiving opening 105 at the top of the mounting base 112 is located, thereby covering the object to be covered (e.g., the housing opening 104).

As shown in FIG. 4, the roll-up curtain 223 is connected to the shaft 302 at a first end. The roll-up curtain 223 is connected to the covering member 120 at a second end opposite the first end, such that the roll-up curtain 223 can be unwound under the drive of the covering member 120. In the present disclosure, the roll-up curtain 223 is movably connected to the covering member 120 at the second end. Specifically, the covering device further includes two connecting pins 421. The second end of the roll-up curtain 223 is connected to the two connecting pins 421. The second covering plate 212 is provided with two receiving slots 411. The two connecting pins 421 are received in the two receiving slots 411, respectively. The receiving slots 411 are arranged on opposite sides of the second covering plate 212, and are formed by being recessed inwardly from an outer surface of the second covering plate 212. A direction of extension of the receiving slots 411 is substantially at an angle to a direction of extension of the axis X. In an exemplary embodiment of the present disclosure, the direction of extension of the receiving slots 411 is perpendicular to the direction of extension of the axis X, and when the second covering plate 212 is rotated relative to the mounting base 112, the direction of extension of the receiving slots 411 is perpendicular to the direction of extension of the axis X at all times. The connecting pins 421 can move in the direction of extension of the receiving slots 411. When the connecting pins 421 are located at ends of the receiving slots 411 away from the axis X, the roll-up curtain 223 is wound. When the connecting pins 421 are located at ends of the receiving slots 411 close to the axis X, the roll-up curtain 223 is unwound.

It should be noted that although two connecting pins 421 and two receiving slots 411 are shown in the present disclosure, at least one connecting pin 421 and at least one receiving slot 411 fall within the scope of protection of the present disclosure.

As shown in FIG. 4, the covering device further includes a reset member 401. The reset member 401 is configured to wind the roll-up curtain 223 during the switching of the covering member 120 from the covering state to the idle state. As an example, the reset member 401 may be a spring arranged on the roll-up curtain 223, such that the roll-up curtain 223 has a tendency to be wound.

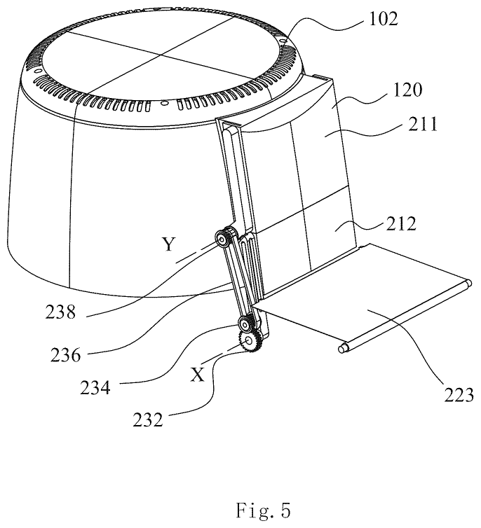

FIG. 5 is a partial perspective view of the covering device with the covering member 120 in the covering state and the receiving opening cover 222 in the closed state. The process of the covering device covering the housing opening 104 of the vehicle-mounted member housing 102 will be described below with reference to FIG. 5 and FIG. 1 in which the covering member 120 of the covering device is in the idle state and the receiving opening cover 222 is in the open state.

As shown in FIGS. 5 and 1, when it is desired to cover the housing opening 104 of the vehicle-mounted member housing 102, the driving device 116 drives the first gear 232 to rotate about the axis X in a first direction of rotation (e.g., counterclockwise). Since the first gear 232 is fixedly connected to the second covering plate 212, the second covering plate 212 also rotates about the axis X in the first direction of rotation. Since the first gear 232 externally meshes with the second gear 234 and the second gear 234 is in transmission connection with the third gear 238 by means of the drive belt 236, the third gear 238 can rotate the first covering plate 211 about the axis Y in a second direction of rotation (e.g., clockwise) relative to the second covering plate 212. Thus, the first covering plate 211 and the second covering plate 212 rotate in opposite directions to move from the idle state to the covering state, thereby covering the housing opening 104 of the vehicle-mounted member housing 102.

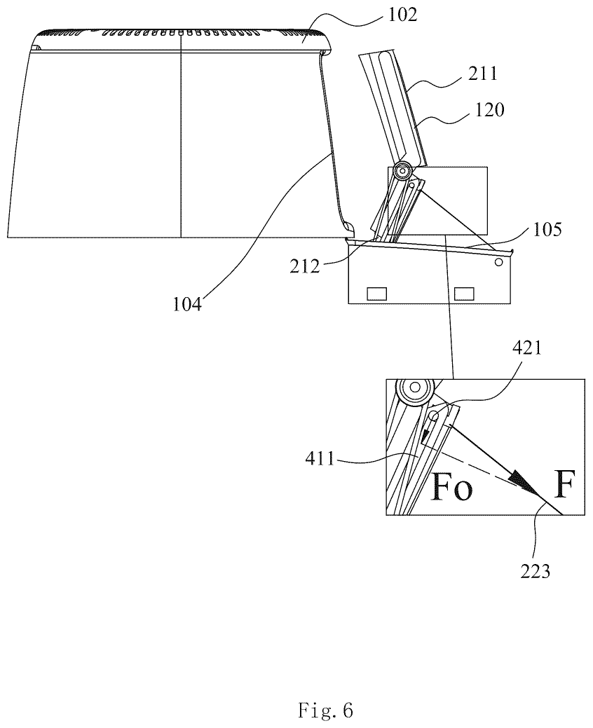

FIG. 6 is a partial side view of the covering device at a moment during the movement of the covering member 120 from the idle state to the covering state and during the movement of the receiving opening cover 222 from the open state to the closed state. As shown in FIG. 6, when the covering member 120 is in the idle state, the roll-up curtain 223 is in the open state and the connecting pins 421 are located at the ends of the receiving slots 411 away from the axis X. During the movement of the covering member 120 from the idle state to the covering state, the ends of the receiving slots 411 away from the axis X are gradually raised due to the movement of the second covering plate 212 about the axis X, such that the roll-up curtain 223 is gradually unwound. Since the reset member 401 always applies a force on the roll-up curtain 223 to maintain the roll-up curtain 223 in tension, the connecting pins 421 are always subjected to a force F in a direction in which the roll-up curtain 223 is unwound. Since the force F is at an angle to the receiving slots 411, the force F has a component Fo in the direction of extension of the receiving slots 411, such that the connecting pins 421 are moved in the receiving slots 411 toward parts of the receiving slots 411 close to the axis X, until the connecting pins 421 reach the ends of the receiving slots 411 close to the axis X. Thereby, the roll-up curtain 223 moves from the open state to the closed state, and the roll-up curtain 223 closes the receiving opening 105.

It should be noted that although the roll-up curtain 223 is used as one embodiment of the receiving opening cover 222 in the present disclosure, it may be understood by those skilled in the art that in another embodiment, the receiving opening cover 222 may also include a component that can be folded and unfolded in multiple layers without being wound around the shaft 302. In another embodiment, the receiving opening cover 222 may also be a plate that can be connected to the covering member 120 and is brought into its open and closed states by movement and/or rotation.

It should be noted that although the first covering plate 211 and the second covering plate 212 are used as the covering member 120 in the present disclosure, it may be understood by those skilled in the art that in another embodiment, covering members 120 that include one covering component/covering plate all fall within the scope of protection of the present disclosure.

The vehicle-mounted member housing is arranged on a roof of a vehicle, and a sheet metal on the roof needs to be provided with an opening aligned to the receiving opening such that the covering member can extend out of the vehicle. However, when the covering member extends out of the vehicle and covers the housing opening of the vehicle-mounted member housing, the opening of the sheet metal on the roof is in the open state and dust can enter the roof. Even if an additional covering member is provided for the opening of the sheet metal, an additional driving device needs to be provided, resulting in a complex structure.

In the covering device of the present disclosure, the covering functions of the covering member and the receiving opening cover can be achieved by means of one driving device, without needing to provide a separate driving device for the receiving opening cover. Further, since the driving device can simultaneously move the covering member and the receiving opening cover, it takes short time to bring the covering member into the covering state and the receiving opening cover into the closed state.

Furthermore, since the covering member includes the first and second covering plates which move relative to each other, and the first covering plate is superposed on second covering plate when the covering member is in the idle state, the size of the covering member is small, resulting in a small opening area across the radius of the vehicle.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Accordingly, the exemplary embodiments of the present disclosure set forth above are illustrative in nature and not meant to be limiting. Therefore, various changes may be made without departing from the spirit or scope of the present disclosure. Therefore, the present disclosure is intended to encompass all known or carlier disclosed alternatives, modifications, variations, improvements, and/or substantial equivalents.

### LIST OF REFERENCE NUMERALS

Covering device 100
Vehicle-mounted member housing 102
Housing opening 104
Receiving opening 105
Housing cavity 106
Mounting base 112
Receiving cavity 114
Driving device 116
covering member 120
Transmission device 202
First covering plate 211
Second covering plate 212
Receiving opening cover 222
Roll-up curtain 223
First gear 232
Second gear 234
Drive belt 236
Third gear 238
Through hole 301
Shaft 302
Reset member 401
Receiving slot 411
Connecting pin 421

What is claimed is:

1. A covering device, comprising:
a mounting base defining a receiving cavity and provided with a receiving opening;
a covering member connected to the mounting base and having a covering state and an idle state;
a receiving opening cover connected to the covering member and having an open state in which the receiving opening cover opens the receiving opening and a closed state in which the receiving opening cover closes the receiving opening; and
a driving device configured to drive the covering member to switch between the covering state and the idle state;
wherein when the covering member is in the idle state, the receiving opening cover is in the open state, and the covering member is received in the receiving cavity and covers the receiving opening; and
wherein when the covering member is in the covering state, the covering member is at least partially located outside the receiving cavity and the receiving opening, and the receiving opening cover is driven by the covering member to the closed state.

2. The covering device of claim 1, further comprising:
a shaft arranged on the mounting base;
wherein the receiving opening cover comprises a roll-up curtain, the roll-up curtain is connected to the shaft at a first end and is capable of being wound by being wound around the shaft, and the roll-up curtain is connected to the covering member at a second end opposite the first end and is capable of being unwound under the drive of the covering member, and
wherein the receiving opening cover is in the open state when the roll-up curtain is wound, and the receiving opening cover is in the closed state when the roll-up curtain is unwound.

3. The covering device of claim 2,
wherein the covering member is configured to rotate about an axis relative to the mounting base to switch between the covering state and the idle state; and
wherein the roll-up curtain is movably connected to the covering member at the second end.

4. The covering device of claim 3,
wherein the covering member is provided with a receiving slot, the receiving slot being arranged at an angle to the axis;
wherein the covering device further comprises a connecting pin, the roll-up curtain is connected to the connecting pin at the second end, and the connecting pin is received in the receiving slot and is movable along the receiving slot; and
wherein the connecting pin is at an end of the receiving slot away from the axis when the roll-up curtain is wound, and the connecting pin is at an end of the receiving slot close to the axis when the roll-up curtain is unwound.

5. The covering device of claim 4, wherein the receiving slot is arranged perpendicular to the axis.

6. The covering device of claim 4,
wherein the covering member is provided with two receiving slots, the two receiving slots being located on opposite sides of the covering member, respectively; and
wherein and the covering device further comprises two connecting pins, the two connecting pins being received by the two receiving slots, respectively.

7. The covering device of claim 2, further comprising:
a reset member configured to cause the roll-up curtain to be wound during the switching of the covering member from the covering state to the idle state.

8. The covering device of claim 4,
wherein the covering member comprises a first covering plate and a second covering plate, the first covering plate being rotatably connected to the second covering plate, and the second covering plate being rotatably connected to the mounting base;
wherein when the covering member is in the idle state, the covering member is folded such that the first covering plate is superposed on the second covering plate, and when the covering member is in the covering state, the first covering plate and the second covering plate are joined together to collectively cover an object to be covered; and
wherein the receiving slot is provided on the second covering plate.

9. The covering device of claim 8, further comprising:
a transmission device by which the driving device drives the first covering plate and the second covering plate to move.

10. The covering device of claim 9, wherein the transmission device comprises:
a first gear fixedly connected to the second covering plate, the driving device being configured to cause the first gear to rotate;
a second gear arranged on the second covering plate and meshing with the first gear;
a third gear fixedly connected to the first covering plate; and
a drive belt arranged around the second gear and the third gear such that a rotation of the second gear causes a rotation of the third gear.

11. A vehicle-mounted device, comprising:
a vehicle-mounted member housing comprising a housing opening; and
a covering device of any claim 1;
wherein the covering member opens the housing opening when the covering member is in the idle state; and
wherein the covering member covers the housing opening when the covering member is in the covering state.

12. The vehicle-mounted device according to claim 11,
wherein the vehicle-mounted member housing is configured to house a vehicle-mounted member, and the vehicle-mounted member comprises a vehicle-mounted camera, a vehicle-mounted laser radar, a vehicle-mounted detection radar, a vehicle charging port or a vehicle rearview mirror.
